(19) United States
(12) Patent Application Publication
(10) Pub. No.: US 2013/0277603 A1
(43) Pub. Date: Oct. 24, 2013

(54) PROCESS FOR PREPARATION, APPLICATION AND RECOVERY OF ABSORBENT MATERIAL FOR NONPOLAR COMPOUNDS OR MIXTURES

(71) Applicants: Geraldo Magela De Lima, Belo Horizonte (BR); Jadson Cláudio Belchior, Belo Horizonte (BR); Geison Voga Pereira, Belo Horizonte (BR); Fabrício Vieira De Andrade, Vespasiano (BR); Márcio Guimarães Coelho, Belo Horizonte (BR); Daneile Santos Cavanellas Gomes, Belo Horizonte (BR); Nathália Gabriela Silva Pinheiro, Belo Horizonte (BR)

(72) Inventors: Geraldo Magela De Lima, Belo Horizonte (BR); Jadson Cláudio Belchior, Belo Horizonte (BR); Geison Voga Pereira, Belo Horizonte (BR); Fabrício Vieira De Andrade, Vespasiano (BR); Márcio Guimarães Coelho, Belo Horizonte (BR); Daneile Santos Cavanellas Gomes, Belo Horizonte (BR); Nathália Gabriela Silva Pinheiro, Belo Horizonte (BR)

(73) Assignee: UNIVERSIDADE FEDERAL DE MINAS GERAIS, Belo Horizonte (BR)

(21) Appl. No.: 13/810,203

(22) PCT Filed: Jul. 14, 2011
(86) PCT No.: PCT/BR2011/000236

§ 371 Date: May 24, 2013

(30) Foreign Application Priority Data
Jul. 14, 2010 (BR) PI1005885-0
Jul. 14, 2011 (BR) 014110002210

(51) Int. Cl. B01J 20/26; C02F 1/28; B09C 1/08; B01J 20/32; B01J 20/34

(52) U.S. Cl. CPC B01J 20/262; B01J 20/3231; B01J 20/3483; B09C 1/08; C02F 1/288
USPC 252/180; 502/402; 502/22; 502/31; 502/33; 427/372.2; 427/393.6; 405/266; 210/660

(57) ABSTRACT

The present invention describes the method for preparing, using and recovering an absorbent material for apolar compounds or mixtures of apolar compounds, such as organic solvents, mineral oil and derivatives thereof, lubricant oils, edible oils, inter alia. The absorbent material is composed of an inorganic matrix of high porosity, low density and high mechanical resistance. This matrix is rendered water-proof, thus acquiring the property of absorbing apolar compounds or mixtures of apolar compounds.

The present invention describes the process for preparing, using and recovering an absorbent material for apolar compounds or mixtures of apolar compounds, such as organic solvents, petroleum and derivatives, lubricant oils, edible oils, but not limited thereto. The absorbent material is composed of an inorganic matrix of high porosity, low density and high mechanical resistance. This matrix is rendered water-proof, thus acquiring the capacity of absorbing apolar compounds or mixtures of apolar compounds.

The use of apolar compounds in the chemical industries generates much waste of organic solvents and also a high frequency of environmental accidents caused by spilling of these compounds in natural aquifers, such as oceans, seas, rivers, mangroves, lakes and lagoons, as well as the contamination of the soil at the river banks and beaches, damaging the whole aquatic and land fauna and flora. Such environmental accidents also prejudice several economic and industrial sectors, such as fishing, farming, water treatment systems, among others.

Thus, in order to minimize the costs for revitalizing the areas degraded by oil spilling or for revitalizing rivers, lakes, lagoons contaminated by similar compounds, several measures for preventing damages to the environment have been implemented, such as the construction of more resistant oil pipelines, implementation of systems for treating industrial wastes, among others.

The prior art describes some materials that may be of apolar compounds, as for example, patent BR9103357 (A process for obtaining granulated or powdered rubber with a wide range of oil absorption, derivatives thereof and other solvents, 1991), which describes the application of vulcanized rubber in the form of powder or granules for absorbing oils and derivatives thereof.

Another example of absorption of apolar compounds is described in patent application BR0702220 (A process of producing a recyclable web for absorbing petroleum, 2007), which describes the use of TNT fabric composed by pressed viscose and polyester, then the material should be dipped into a bath containing bactericide, fungicide and oil for storing the product. In the description of the technology, one finds the drawback of using biocidal compounds that may cause contamination of the aquatic environment with bactericidal and fungicidal agents during the process of removing, for example, spilt oil, which may further aggravate the environmental damages.

For the use of inorganic matrix to absorb apolar compounds, one finds patent application BR0701585 (A process for obtaining low-density porous ceramics with controlled closed and open porosity, 2008), which describes the preparation of a mixture composed of clay, maize and cassaya starch, EPS wax and bentonite as a binding agent. This mixture is homogenized and heated until the starch is burned, forming open pores for the absorption of petroleum and closed pores for the material to float in an aqueous medium. However, the mechanical resistance of the composite formed impairs the reuse thereof. In order to enhance the mechanical resistance, one can use more bentonite, but the number of closed pores, that is, inaccessible to the absorbed compound, is drastically increased, thus reducing the absorption capacity of the material.

There are other technologies that can be used for the absorption or removal of apolar compounds from natural areas that have been degraded by accidents involving the spilling or leaking of petroleum, solvents, oils or similar substances. For instance, one can cite the use of bird feathers for absorption (BR0005023, “A method and device for holding and absorbing petroleum, derivatives thereof, oils of animal or vegetable origin and other hydrocarbons that are insoluble in water, on aquatic surfaces or in natural soils, and for filtration”, 2002), or the use of digestive enzymes for decomposition of petroleum (U.S. Pat. No. 4,689,297, “Dust free particulate enzyme formulation”, 1985).

The technologies described in the above-cited documents present variable that may render their implementation unfeasible, chiefly in the face of large amounts of petroleum to be absorbed, as is the case with the sinking of oil extraction platforms or cargo ships, the bursting of oil pipelines caused, for instance, by earthquakes, terrorist attacks and explosions.

### BRIEF DESCRIPTION OF THE FIGURES

FIG. 1 shows the absorption of petroleum by using a filter constituted by absorbent material.

FIG. 2 shows the absorption of gasoline by using a film constituted by an absorbent material.

### DETAILED DESCRIPTION OF THE INVENTION

The present invention describes a process for preparing and using an absorbent material for apolar compounds of mixtures thereof. This invention consists in fixing a compound having high affinity for apolar substances on a low-density and high-porosity inorganic matrix. The support matrix consists of autoclaved cellular concrete, which may be replaced by a volcanic material, as for example, pumice with a high silica content, or still in inorganic substances that do not alter the absorption compound and its properties, thus being non-limitative, while the absorption compound consists of silicone, linseed oil, glycerin, castor oil, polystyrene, soybean oil, almond oil, avocado oil, coconut oil, cod oil, without limitation thereto.

The preparation of the absorbent material of apolar compounds consists in dipping the matrix of autoclaved cellular concrete or volcanic material into a solution of silicone or linseed oil, glycerin, castor oil, polystyrene, soybean oil, almond oil, avocado oil, coconut oil or cod oil, not limited to these, in ether with a concentration ranging from 1 to 20% (v/v). The second step consists in carrying out the thermal treatment of the impregnated material for fixing the silicone, not limited thereto, in the interstices of the matrix of autoclaved cellular concrete or equivalent absorbent material. The thermal treatment should be made at a temperature ranging from 60 to 250° C. for a period ranging from 1 to 24 hours. During the thermal treatment, the silicone, not limited thereto, interacts with the inorganic matrix of autoclaved cellular concrete, fixing it irreversibly.

The autoclaved cellular concrete is composed by a mixture of silicates, aluminates, calcium and/or magnesium carbonates, and a few iron, titanium oxides, but in lower proportion. The autoclaved cellular concrete exhibits properties that make it suitable as a support for absorption of apolar compounds. Its density ranges from 600 to 700 kg/m³, thus enabling the material to remain on the surface of aquatic effluents. The surface area of the autoclaved cellular concrete ranges from 18000 m²/kg to 25000 m²/kg, but it may be raised up to 66000 m²/kg during the thermal treatment process.

The autoclaved cellular concrete may be replaced with pumice with high silica content. This material of volcanic origin exhibits properties similar to those of the autoclaved cellular concrete, that is, low density (˜600 kg/m³), high porosity and low solubility of its constituents in water.

During the thermal treatment process, the ether used in solubilizing the silicone can be collected with the aid of a condenser, enabling it to be reused in new processes of impregnating silicone into the autoclaved cellular concrete.

The absorbent material may be applied in processes of decontamination of effluents that contain homogeneous contaminants, but with apolar characteristics, as for example, phenol, or contaminants that are immiscible in water and that are on the surface of the aquatic systems, as for example, petroleum, lubricant oils, oils for preparing foods, industrial solvents such as toluene, benzene, hexane, cyclohexane and derivatives of these solvents.

The high interaction of the absorbent material with apolar compounds enable it to be used for decontaminating artesian wells or cisterns contaminated with leaching of components that are partly miscible (partially apolar) by rainfalls or by the agricultural irrigation processes.

After the absorption process, the material may be regenerated in two different ways, which depend on the nature of the compounds absorbed. For volatile components such as organic solvents and gasoline, the material may be subjected to a thermal treatment at a temperature between 30 and 400° C., and the absorbed material may be collected through condensers. In this case, the regenerated absorbent material does not exhibit loss in the absorption capability, since in this range of temperature silicone does not exhibit evolution of the thermal decomposition process, and continues to be fixed in the matrix of autoclaved cellular concrete.

For viscous compounds or mixtures having low contents of volatile compounds such as lubricant oils and petroleum, the saturated material may be regenerated by fractioned distillation of the more volatile compounds, which exhibit boiling point lower than 400° C. For the extraction of the less volatile components, one may still reduce the pressure in the distillation column, thus preventing the rise in temperature. Another resource for regenerating the absorbent material corresponds to lixiviation of the absorbed component in a bath containing ether or another volatile solvent, such as acetone. After drying the absorbent material at room temperature or in a heating system at up to 300° C., the absorbent material is ready for reuse. The regeneration by solvent bath reduces the absorption potential of the material. The magnitude of this reduction should be evaluated in accordance with the absorbed material and will be demonstrated in the presentation of the examples.

The absorbent material may also be applied in decontamination of environments containing high amounts of apolar substances, as for example in spillage of petroleum in oceans, seas, lakes, lagoons, bays, rivers, leak of oil pipelines in rivers, mangroves, lagoons, lakes, and even spillage of petroleum in the soil. The latter case of use involves a process with less kinetic yield, since the migration of the contaminant depends directly on the exposure area and the fluidity of the contaminant with the absorbent material.

The absorbent material may be applied in constructing filters for separation of apolar compounds, either dispersed or emulsified, such as petroleum, degraded oil, but not limited thereto.

The technology may be better understood with reference to the analysis of the following examples, which are not limitative.

### Example 1

### Preparation of the Absorbent Material

In order to carry out the absorption tests of this invention, one has used 100 g of autoclaved cellular concrete, fragmented in cubes of about 2 g each. For the impregnation of silicone, one used 200 mL of silicone solution, in ether, ranging from 1 to 5% (v/v). The pieces of autoclaved concrete were dipped into the solution for about 5 minutes and then dried in a muffle at 150° C. for 1 hour.

The temperature and the heating time may be adjusted according to Table 1.

TABLE 1
Temperature and time interval for
rendering the material water-proof

| Temperature range (° C.) | Time range (hour) |
|---|---|
| 60-80 | 10-7 |
| 80-100 | 7-6 |
| 100-120 | 6-5 |
| 120-140 | 5-4 |
| 140-160 | 4-2 |
| 160-250 | 2-1 |

### Example 2

### Use of the Absorbent Material for Absorbing Petroleum

In the petroleum absorption test one used 30 mL of synthetic seawater solution, called saline solution, wherein about 10 mL of petroleum was added, this amount being sufficient to involve the absorbent material. The absorbent material was added and kept in contact with the petroleum for 3 hours, being monitored every 5 minutes. This procedure was carried out for temperatures of 10, 20, 30, 40, 50 and 60° C. The total absorption rate is shown in Table 2.

TABLE 2
Temperature and time interval for
rendering the material water-proof

| Temperature (° C.) | Absorption % (m/m) |
|---|---|
| 20 | 120 |
| 30 | 115 |
| 40 | 100 |
| 50 | 96 |
| 60 | 97 |

### Example 3

### Use of the Absorbent Material for Gasoline Absorption

In the absorption tests for gasoline, one used 30 mL of water and about 10 mL of common gasoline. In this test the material was regenerated 4 times. Table 3 shows the absorption percentage of each use cycle. For each absorption the material was contacted with gasoline for 30 minutes.

TABLE 3
Data of the absorption/regeneration cycle for the gasoline
absorption process using the absorbent material

| Cycle | Mass increase (%) (m/m) |
|---|---|
| 1 | 46 |
| 2 | 65 |
| 3 | 67 |
| 4 | 50 |

In the regeneration of the material one used the distillation process described before. The material saturated with the gasoline was slightly heated (˜60° C.), so that the gasoline could volatilize, and after this period the material was ready for the next absorption cycle.

After the first absorption (Table 3), one observes a significant increase in the absorption material, passing from 46% to 65%. This behavior can be justified as being an increase in the affinity of the absorbent material for gasoline, since the regeneration with a slight heating is not capable of removing the whole gasoline absorbed. Thus, after the first absorption, the interactivity of the material with gasoline is maximized due to the gasoline traces that remain in the material.

### Example 4

### Use of the Absorbent Material for Toluene Absorption

In this absorption test for toluene, one used 30 mL of water and 10 mL of toluene. The toluene absorption was tested in two different times of exposure of the material to the solvent. For the time of 30 minutes, one observed an increase in mass of 60% (m/m), while for the time of 60 minutes the increase was of 63% (m/M).

### Example 5

### Use of the Absorbent Material for Phenol Absorption

For phenol absorption one used a 7% (v/v) aqueous solution of phenol and exposure time for each 30-minute absorption. Table 4 shows the data achieved (increase in mass of material) for 5 absorption test.

TABLE 4
Data of the absorption/regeneration cycles for the phenol
absorption process using the absorbent material

| Cycle | Increase in mass (%) (m/m) |
|---|---|
| 1 | 23 |
| 2 | 57 |
| 3 | 30 |
| 4 | 25 |
| 5 | 28 |
| Average | 32.6 |

For a phenol absorption experiment similar to that carried out above, but using a saturated solution of sodium chloride and a 7% (v/v) solution of phenol, one observed an average increase of 63%.

### Example 6

### Use of the Absorbent Material for Petroleum Absorption in Soil

In order to test the potential of decontamination of the material in soils, about 100 g of send was mixed with 25 mL of petroleum and 25 mL of water, this mixture exhibiting a viscous aspect (slurry). Then a piece (4 g) of absorbent material was contacted with the mixture of sand, petroleum and water. After 1 hour of absorption, one observed an increase of 55% (m/m) in the material, and after 2 hours the increase was of 60%. For decontamination of soils, beaches and mangroves, the absorption process is not as accelerated as in a liquid medium, because the low fluidity of the viscous medium impairs the absorption process. However, the present invention demonstrates a possible solution for decontamination of solid environments.

### Example 7

### Construction of a Filter for the Absorption of Apolar Compounds

The absorbent material may be pre-molded for the construction of a selective filter system for the separation of apolar compounds. In this patent application, the absorbent material was molded in a cylinder having 1 cm of diameter and 1 to 4 cm of length, but not limited thereto. Then the material was coupled to a sealed tube. The tube was exposed to a mixture of sea water and petroleum in the proportion of 10% (v/v) for 15 days. In this utilization, the interactivity between the apolar compound and the absorbent material favors the separation of phases; the apolar compound is separated into the container. The apolar compound needs to be regenerated, since the separation process does not cause any type of physical or chemical modification.

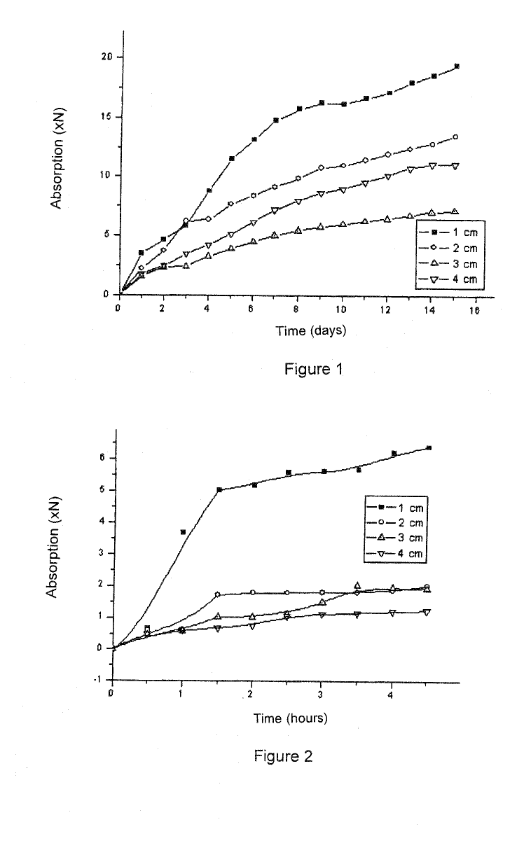

The application of a filter using the absorbent material maximizes the absorption potential per mass unit. FIG. 1 shows daily absorption of 4 cylindrical filters having 1 cm of diameter and 1, 2, 3 and 4 cm of length. The total absorption for the cylinder 1 is 17 times its mass in petroleum, corresponding to a rate of 1.3 kg of petroleum per kg of absorbent material per day, for the cylinder 2 the total absorption corresponds to 13 times, and for the cylinders 3 and 4 the yield is 6 times.

For compounds having lower viscosity, as for example gasoline, the absorption potential becomes higher, as is presented in FIG. 2. For comparison with petroleum absorption, the daily absorption rate is of 33 kg (˜47 liters) of gasoline per kg of material per day. For the 1 cm cylinder the yield is of 7 times the cylinder mass in about 5 hours' absorption. Extrapolating this yield for 15 days, one achieves a yield of 56000%. For the cylinders 2, 3, and 4 the average absorption is of 2 times in 5 hours, that is, 14000% in 15 days.

1-15. (canceled)

16. A process of preparing an absorbent material for apolar compounds or mixtures, the process comprising:
(a) impregnating with an ether solution of concentration ranging from 1% (v/v) to 20% (v/v) an absorption compound selected from the group consisting of silicone, linseed oil, glycerin, castor oil, polystyrene, soybean oil, almond oil, avocado oil, coconut oil, and cod oil, in an absorbent matrix comprising autoclaved cellular concrete or volcanic material; and
(b) thermal treatment at a temperature ranging from 60° C. to 250° C. for a period ranging from 1 hour to 24 hours.

17. The process of preparing an absorbent material for apolar compounds or mixtures, according to (a) of claim 16, wherein the volcanic material is preferably pumice with high silica content.

18. The process of preparing an absorbent material for apolar compounds or mixtures, according to claim 17, wherein the absorption material does not comprise silicone when the volcanic material is preferably pumice with high silica content.

19. An absorbent material for apolar compounds or mixtures, characterized by comprising an absorbent matrix selected from the group comprising autoclaved cellular concrete or volcanic material impregnated with an absorption material selected from the group consisting of liquid silicone, linseed oil, glycerin, castor oil, polystyrene, soybean oil, almond oil, avocado oil, coconut oil, and cod oil, resulting from the process of claim 16.

20. The absorbent material for apolar compounds or mixtures, according to claim 19, wherein the volcanic material is preferably pumice with high silica content.

21. The absorbent material for apolar compounds or mixtures, according to claim 20, wherein the absorption material does not comprise silicone when the volcanic material is preferably pumice with high silica content.

22. A method of recovering absorbent material and absorbed material, the method comprising (a) thermal treatment from 30° C. to 400° C. for the absorbent material and
(b) collecting the absorbed material through condensers with either normal or reduced pressure or
(c) leaching the absorbed component in a bath containing a volatile solvent, and drying the absorbent material at room temperature or in a heating system up to 300° C.

23. The method of recovering the absorbent material according to (c) of claim 22, wherein the volatile solvent is selected from the group consisting of ether, acetone, and hexane.

24. Use of the absorbent material according to claim 19, characterized by comprising absorption of organic compounds selected from the group consisting of phenol, toluene, benzene, hexane, cyclohexane, and derivatives of these solvents, or absorption of apolar mixtures selected from the group consisting of petroleum, lubricant oils, degraded oils, and edible oils.

25. Use of the absorbent material according to claim 19, characterized by comprising absorption in an environment contaminated with apolar substances.

26. The use of the absorbent material according to claim 24, characterized in that it decontaminates environment comprising sea, river, lagoon, or soil contaminated with apolar industrial waste, petroleum, or a petroleum derivative.

27. The use of the absorbent material according to claim 24, characterized in that it decontaminates cisterns or artesian wells contaminated with leaching of apolar components.

28. Use of the absorbent material according to claim 19, characterized in that it is used for construction of a pre-molded filter for separating apolar compounds, either dispersed or emulsified in polar solvents.
